(19) United States
(12) Patent Application Publication
(10) Pub. No.: US 2026/0019747 A1
(43) Pub. Date: Jan. 15, 2026

(54) WEARABLE DEVICE FOR USER AUDIO RECORDING

(71) Applicant: Rewind AI, Inc., Denver, CO (US)

(72) Inventors: Jeremy John Kuempel, San Francisco, CA (US); Venkatesh Kumar, Oakland, CA (US); Everardo Uribe, Los Angeles, CA (US); Dan Siroker, Denver, CO (US); John Robert Hickey, Seattle, WA (US)

(21) Appl. No.: 19/172,419

(22) Filed: Apr. 7, 2025

Related U.S. Application Data
(60) Provisional application No. 63/575,427, filed on Apr. 5, 2024.

(51) Int. Cl. H04R 5/027; H04R 1/40

(52) U.S. Cl. CPC H04R 5/027; H04R 1/406

(57) ABSTRACT

An example operation includes processing audio data to determine a direction of arrival and to identify a person speaking at a particular time.

### CROSS-REFERENCE TO RELATED APPLICATIONS

This application claims the benefit of priority to U.S. Provisional Application No. 63/575,427, filed on Apr. 5, 2024, which is hereby incorporated by reference in its entirety.

### FIELD OF INVENTION

Various embodiments relate generally to encoding, processing and analysis of audio data.

### SUMMARY

The appended claims may serve as a summary of this application.

### BRIEF DESCRIPTION OF THE DRAWINGS

A pendant style microphone array may used to record audio and various embodiments of the invention described herein thereby process the recorded audio in order to identify user voices via a diarization audio processing algorithm.

The present disclosure will become better understood from the detailed description and the drawings, wherein:

FIG. 1A illustrates a front view of an exemplary microphone pendant configuration.

FIG. 1B illustrates a side view of an exemplary microphone pendant configuration.

FIG. 1C illustrates an angled view of an exemplary microphone pendant configuration.

FIG. 1D illustrates an internal view of a top half of an exemplary microphone pendant configuration.

FIG. 1E illustrates another internal view of the top half of an exemplary microphone pendant configuration.

FIG. 1F illustrates an angled view of the sound channels of an exemplary microphone pendant configuration.

FIG. 1G illustrates a cross-sectional dissected side view of t an exemplary microphone pendant configuration.

FIG. 2A illustrates an internal view of the top half of an exemplary microphone pendant configuration.

FIG. 2B illustrates an internal view of the top half of an exemplary microphone pendant configuration.

FIG. 2C illustrates an internal view of the top half of an exemplary microphone pendant configuration.

FIG. 2D illustrates an internal view of the top half of an exemplary microphone pendant configuration.

FIG. 3 illustrates a system diagram for transmitting the received audio data to a remote cloud server to perform audio data diarization processing according to example embodiments;

FIG. 4A illustrates an example process of performing audio data processing according to example embodiments;

FIG. 4B illustrates another example process of performing audio data processing according to example embodiments; and

FIG. 5 is a diagram illustrating an exemplary computer that may perform processing in some embodiments.

### DESCRIPTION

Conventional systems are deficient in processing audio data to determine when an identified (or identifiable) individual is represented in audio data and is beginning to speak, and when that individual stops speaking.

As described herein, a pendant style microphone array may used to record audio. The microphone array includes a plurality of microphones. The microphones may be positioned relative to each other such that coordinates of a positional x/y/z plane can be assigned to a soundwave (or a portion of a soundwave) as the soundwave is received at the microphone array.

Upon capture of audio data by the pendant style microphone array, one or more embodiments of the invention described herein thereby process the captured audio data to generate output that identifies user voices via a diarization audio processing algorithm.

In contrast to conventional systems, various embodiments herein generate data representative of the direction of arrival (DOA) of soundwaves received by the pendant style microphone array. A timestamp may be appended by one or more embodiments to each portion of generated DOA data to indicate a moment in time when a particular portion of a soundwave was received.

Various embodiments process and analyze the DOA data related to one or more soundwaves in order to determine an identity for each voice represented in the DOA data. Since each soundwave originating from a distinct individual will have a different direction of arrival from any other soundwaves originating from other individuals, embodiments herein determine those respective portions of the DOA data that actually represent continuous speech from the same single individual. Respective portions of DOA data that represent continuous speech from the same individual will be associated with DOA data that corresponds with soundwaves (or soundwave portions) within a threshold range of DOA data and consecutive timestamps. A change in a DOA reflected in the DOA data thereby represents commencement of continuous speech by a different individual.

It will be readily understood that the instant components, as generally described and illustrated in the figures herein, may be arranged and designed in a wide variety of different configurations. Thus, the following detailed description of the embodiments of at least one of a method, apparatus, computer readable storage medium and system, as represented in the attached figures, is not intended to limit the scope of the application as claimed but is merely representative of selected embodiments. Multiple embodiments depicted herein are not intended to limit the scope of the solution. The computer-readable storage medium may be a non-transitory computer readable media or a non-transitory computer readable storage medium.

The instant features, structures, or characteristics described in this specification may be combined in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one example. Thus, appearances of the phrases “example embodiments”, “in some embodiments”, “in other embodiments,” or other similar language, throughout this specification can all refer to the same embodiment. Thus, these embodiments may work in conjunction with any of the other embodiments, may not be functionally separate, and the described features, structures, or characteristics may be combined in any suitable manner in one or more embodiments.

Example embodiments provide methods, systems, hardware components, non-transitory computer readable media, devices, and/or networks, which provide a client device, server and/or a client/server model for performing audio data diarization. The process of diarization may include identifying different persons or ‘speakers’ through an audio voice fingerprint analysis process. Diarization is the process of dividing an audio recording into segments that correspond to different speakers which are detected during a speaking event, such as a conversation. Such a process is usually part of a speech-to-text configuration that aims to improve readability for those studying the transcription.

One approach to diarization may include co-indexing segments that belong to the same speaker/person, and establishing speaker boundaries from recorded audio. Diarization can also determine a number of distinct speakers. When used with speech recognition, diarization enables speaker-attributed speech-to-text transcription. Diarization is used with conversation analysis tools such as automatic speech recognition of conversation content. For example, an application programming interface (API) can provide speaker tags or labels along with transcribed audio data which identifies and differentiates between different speakers/persons.

According to example embodiments, machine learning and/or artificial intelligence (AI) algorithms may be implemented to record and ingest audio of one or more persons speaking near a person wearing the device. The pendant worn microphone array may be configured to capture audio data that is then processed and analyzed by one or more embodiments of a diarization algorithm to determine when certain people start and stop speaking when there are multiple speakers in the presence of background noise. One or more embodiments of a diarization algorithm described herein may include or may be based on one or more machine learning and/or artificial intelligence (AI) algorithms.

One example approach may be to use a multi-microphone array to receive soundwaves whereby one or more embodiments then determine and identify a direction of arrival (DOA) of detected audio data when those soundwaves are arriving at the microphone array. One example approach may be to include multiple microphones including but not limited to two dipole microphones and one omnidirectional microphone. For example, two dipole microphones with high attenuation and physically positioned orthogonal to one another creates an x/y/z plane that is used to identify positional coordinates of soundwaves being received by the device based on the identified (DOA) of those soundwaves. Additionally, a clock may be sued to provide a timestamp to the DOA audio data for accuracy. A refresh rate of a digital signal processor (DSP) included in the pendant and/or in the cloud will define how many instances of a DOA are generated for a recorded soundwave.

In operation, the microphone array may record audio and the various embodiments of the invention processes the recorded audio to determine when a particular speaker/person represented in the recorded audio begins and stops speaking in the recorded audio. The positional x/y/z coordinates, timestamps and the audio data may be sent to the cloud server to process the data and match the data to a profile of a person previously known or may create a new profile if the person is not previously known based on previously stored data. In the event that the person is previously known, the matched data can be used to identify the speaker and the identification can be used as a label appended to the transcribed audio data.

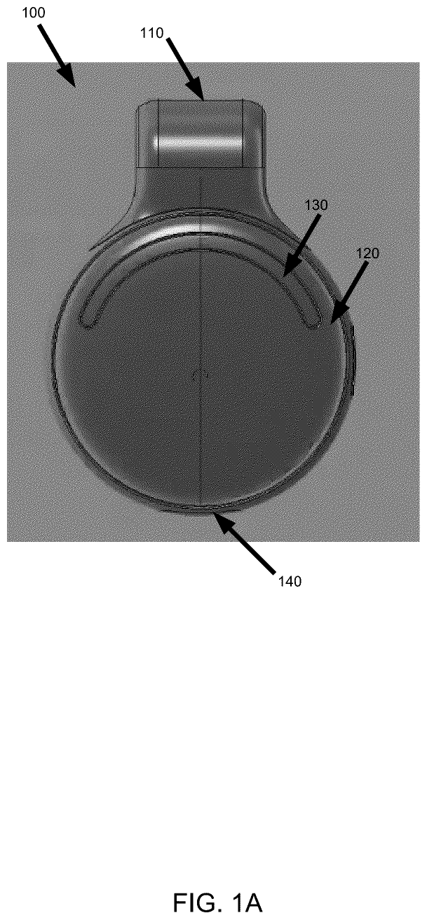

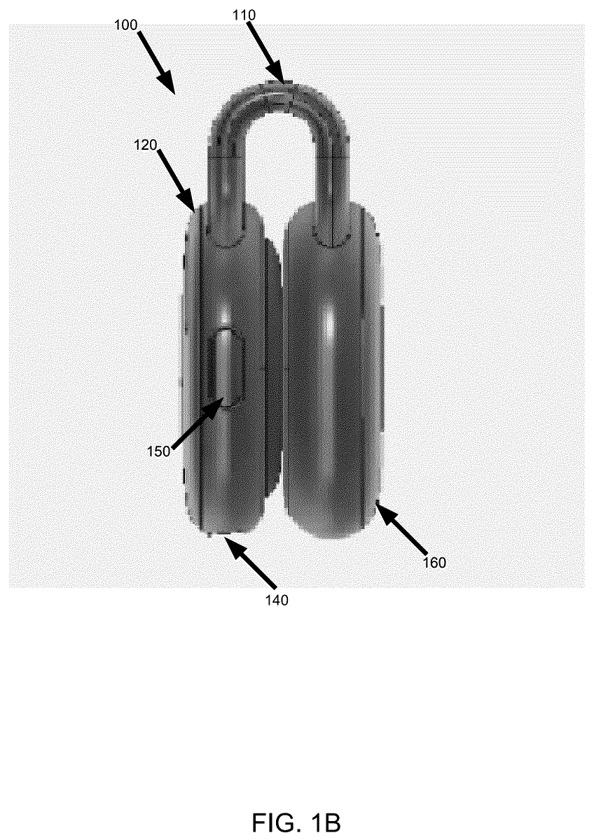

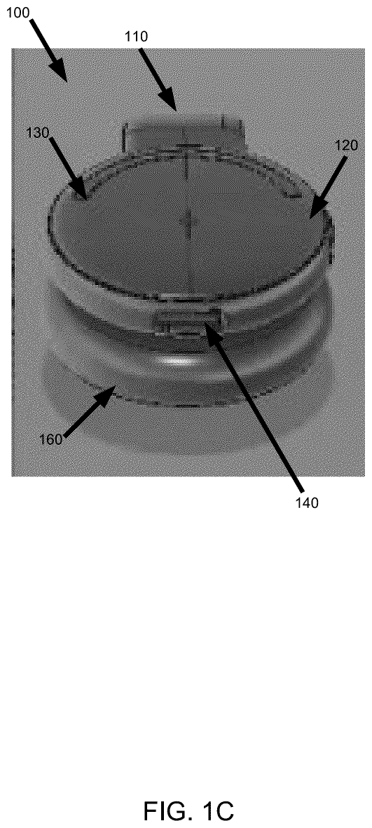

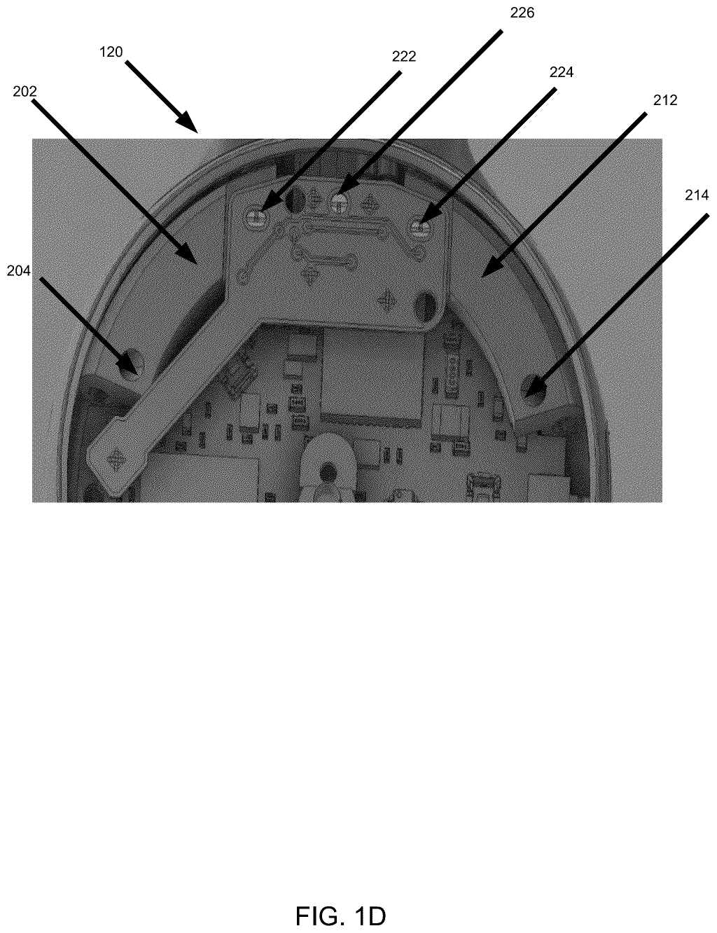

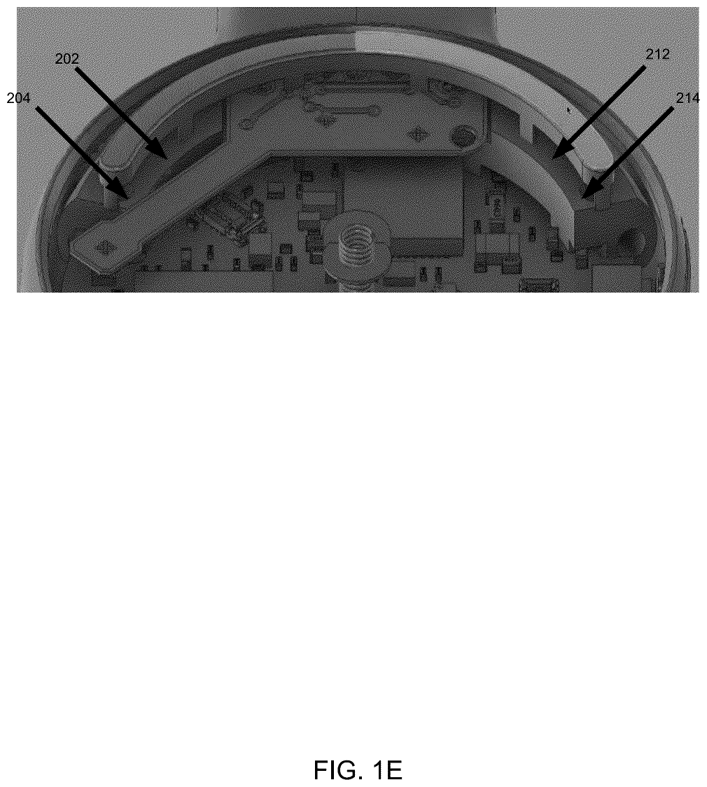

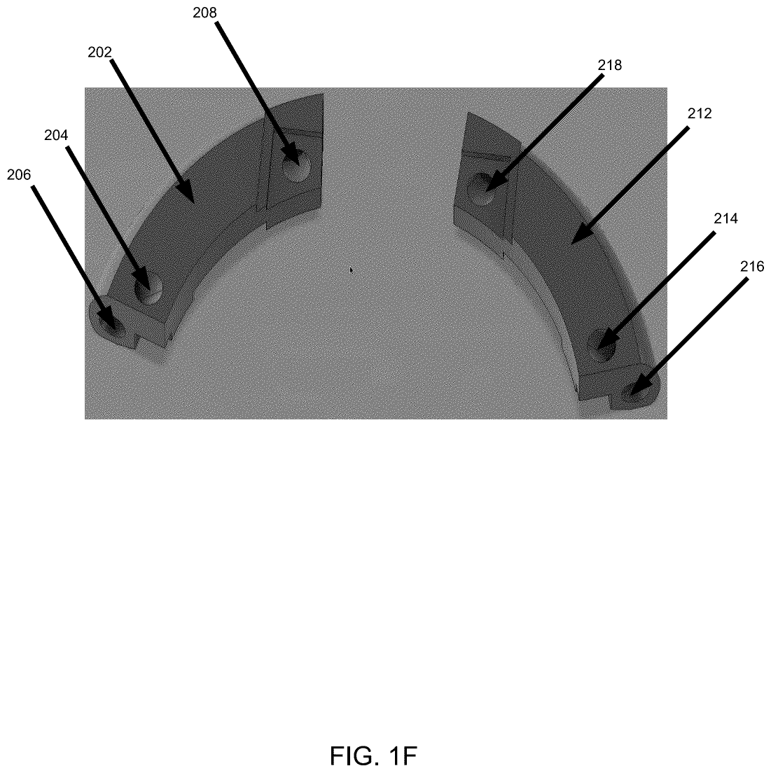

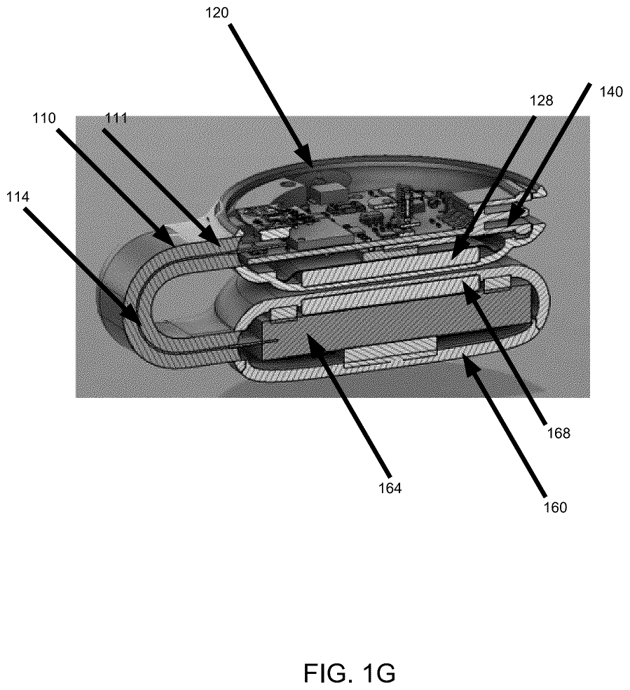

FIG. 1A illustrates a front view of an exemplary microphone pendant configuration for capturing audio data to be encoded, processed and analyzed by one or more embodiments. Referring to FIG. 1A, the microphone pendant 100 may be about 32 mm in diameter which is about the size of a U.S. currency quarter. The pendant may be a similar size or larger or smaller depending on design considerations. The pendant 100 may be magnetically affixed together so both internal sides of the pendant are held together on a person's lapel, collar or shirt pocket, etc. The front side 120 of the pendant houses the microphone array which receives audio signals from a grill or open portion 130 which is disposed as an arced portion on the front side 120. The bottom portion has a charging interface 140, such as a USB compatible interface or comparable charging interface. The front side 120 of the pendant is attached to the back side of the pendant by a flexible clasp/neck portion 110, which may be plastic, rubber, leather or any flexible material.

FIG. 1B illustrates a side view of an exemplary microphone pendant configuration for capturing audio data to be encoded, processed and analyzed by one or more embodiments. Referring to FIG. 1B, the side view illustrates the front side 120 and the back side 160 which may stay in a fixed position by magnets on the internal portions of each side. Or, one side may have a magnet and the other may have a magnetically attractable material such as a ferrous metal. The front side 120 may also have a button 150, such as a power control button that allows or limits power to the electronics inside the pendant 100.

FIG. 1C illustrates an angled view of an exemplary microphone pendant configuration for capturing audio data to be encoded, processed and analyzed by one or more embodiments. Referring to FIG. 1C, the angled view demonstrates the power charging interface 140 of the front side 120 of the pendant and the back side 160 of the pendant.

FIG. 1D illustrates an internal view of a top half of an exemplary microphone pendant configuration for capturing audio data to be encoded, processed and analyzed by one or more embodiments. Referring to FIG. 1D, the internal view of the top half 120, which illustrates the microphone array as a three-microphone configuration. The microphone array has two dipole microphones 222 and 224 and single omnidirectional microphone 226 disposed between the two dipole microphones. The underside of the two dipole microphones 222 and 224 may be affixed directly next to corresponding hollow channels 202 and 212, respectively. The positioning may be contiguous such that no other objects are present between the microphones and the channels. Openings 204 and 214 in the channels provide a tubular structure for the soundwaves to pass along a path to the dipole microphones. It may also be noted that the two channels are position orthogonal to one another to provide orthogonal audio capturing elements which can be used to identify audio signal strengths of the received audio signals and determine the DOAs. The channels and microphones may receive audio signals from the arcuately/bowed shaped grill on the front side of the microphone pendant.

FIG. 1E illustrates another internal view of the top half of an exemplary microphone pendant configuration for capturing audio data to be encoded, processed and analyzed by one or more embodiments. Referring to FIG. 1E, the channels 202 and 212 are disposed under the arcuate/bowed grill so the sound can pass through the grill and into the channels which are disposed such that the ends of the channels are directly aligned with the underside of the dipole microphones to permit the sound to travel along the hollow paths of the channels.

FIG. 1F illustrates an angled view of the sound channels of an exemplary microphone pendant configuration for capturing audio data to be encoded, processed and analyzed by one or more embodiments. Referring to FIG. 1F, the channels 202 and 212 each include hollow channels 206 and 216 with access slots 204 and 208 for channel 202 and 214 and 218 for channel 212. In operation, the audio signals would pass into the slots 204 and 214 and travel towards the dipole microphones through exit points 208 and 218.

FIG. 1G illustrates a cross-sectional dissected side view of an exemplary microphone pendant configuration for capturing audio data to be encoded, processed and analyzed by one or more embodiments. Referring to FIG. 1G, the top side 120 of the pendant includes the majority of electronic components of the device. The charging interface 140 may provide power to the electronic components and may charge a battery 164 in the bottom or back side 160 of the pendant. The two pendant halves are connected by a flexible portion 110 which may have a conduit 114 which provides charge power to the battery 164. Also, in the flexible portion 110 a series of antennas 111 may be disposed, such as a Wi-Fi signal antenna, a BLUETOOTH antenna, and other data transmission antennas since the body of the pendant may be metal and wireless transmission signals may not be readily passed through such a material. The materials 128 and 168 may be a pair of magnets or a magnet and a ferrous material which hold together via a magnetic force to keep the pendant clipped on a user's clothing.

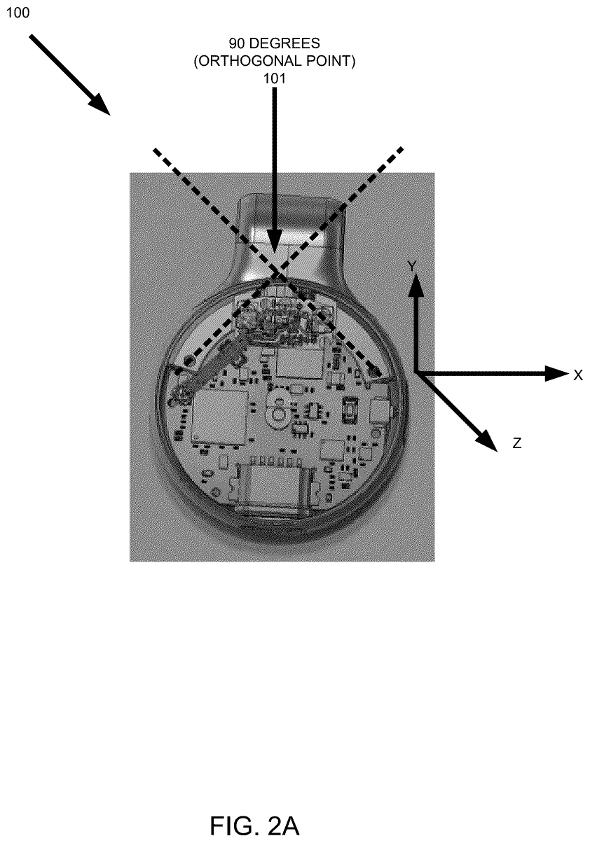

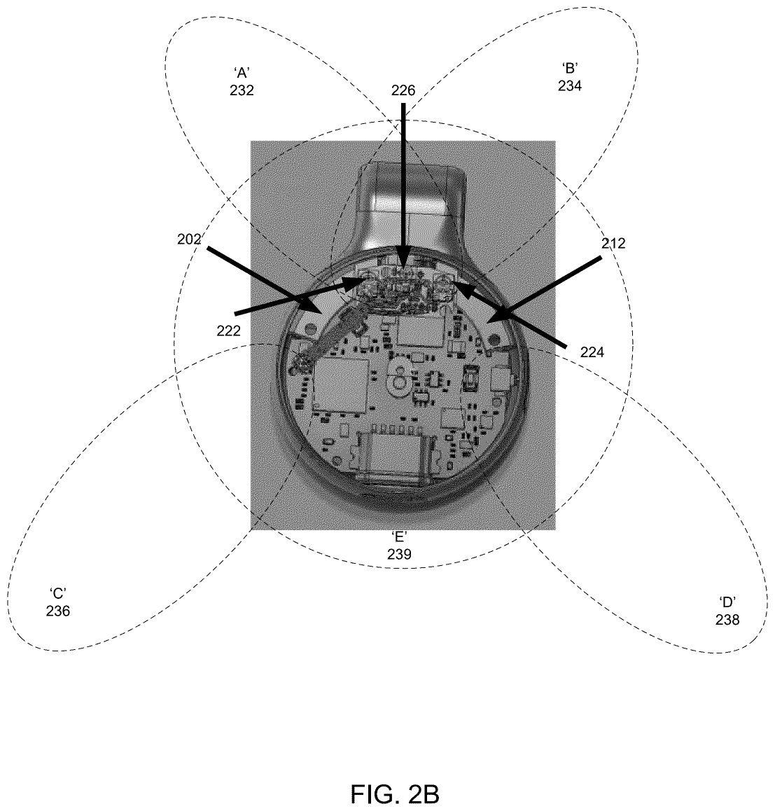

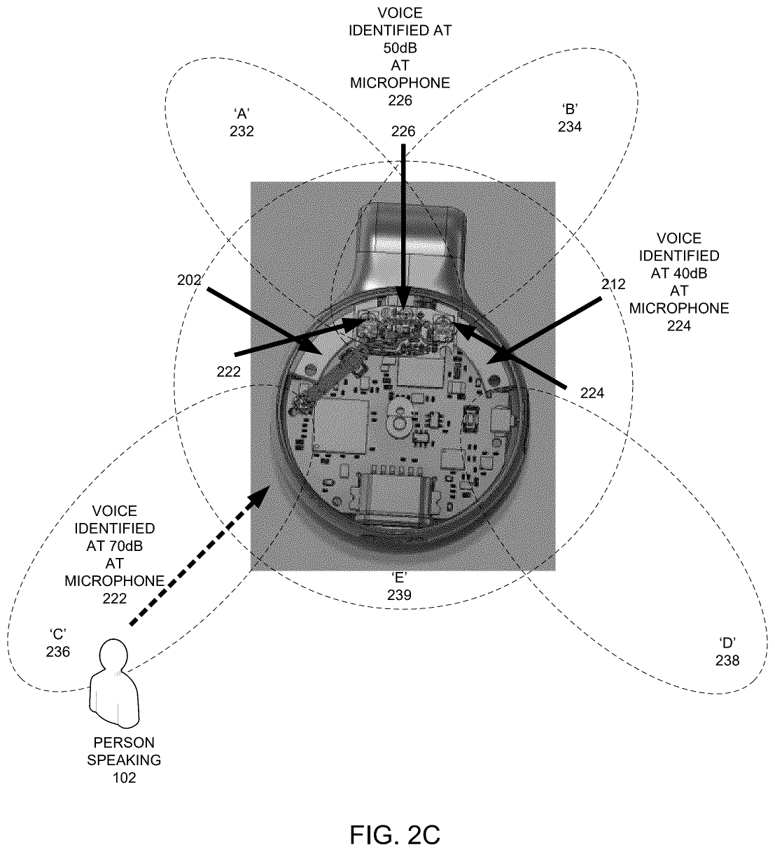

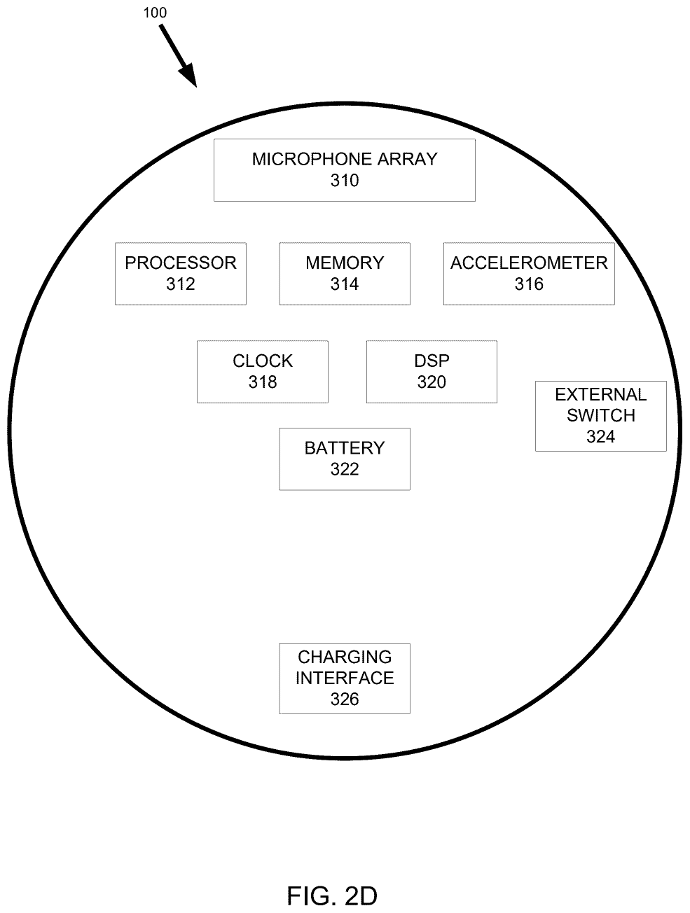

FIG. 2A illustrates an internal view of the top half of an exemplary microphone pendant configuration with an orthogonal axis used to record audio that is thereby represented, encoded and processed according to one or more embodiments of the invention. Referring to FIG. 2A, the channels 202 and 212 of the pendant are aligned in a 90 degree (orthogonal) arrangement such that sound may be one of the dipole microphones 90 degrees away from the sound capturing performed by the other dipole microphone. Such an arrangement of sound capturing devices creates an x/y/z plane of detectable audio signals. When a sound is captured by one microphone and then by another, the sound will have a larger magnitude as measured by one microphone versus another microphone depending a location of the sound source. Detecting the positions of the sound and the identified magnitudes of the sound may provide various DOAs for the sound which can further confirm the presence of one or more persons speaking at various locations in a particular area.

FIG. 2B illustrates an internal view of the top half of an exemplary microphone pendant configuration for capturing audio data to be encoded, processed and analyzed by one or more embodiments. The exemplary microphone pendant configuration may include one or more audio recording lobes associated with the various microphones of the microphone array. Referring to FIG. 2B, the dotted lines and lobe constellations demonstrate certain listening zones of the microphones. In one example, the channel 202 may provide a first dipole microphone with listening zones ‘B’ 234 and ‘C’ 236 which are aligned against the front and rear channel openings of the channel 202. Similarly, the listening zones ‘A’ 232 and ‘D’ 238 may be aligned against the front and rear channel openings of channel 212. Anyone speaking in one of those areas will be identified by the microphone 222 or 224 associated with that area at a higher decibel level than would be detected by the other microphones. Lastly, the omnidirectional microphone 226 will have a substantially even and circular detection area ‘E’ 239 and may assist with DOA determination by providing additional audio data collection information for any detected and recorded audio signals.

FIG. 2C illustrates an internal view of the top half of an exemplary microphone pendant configuration for capturing audio data to be encoded, processed and analyzed by one or more embodiments. The exemplary microphone pendant configuration may include one or more audio recording lobes associated with the various microphones of the microphone array being used to record a user's voice. Referring to FIG. 2C, the example includes a person 102 speaking about 3 meters away from the pendant device in a direction that is aligned with the detection area 236. The audio captured by the pendant via microphone 222 will have a significantly higher magnitude than the omnidirectional microphone 226 which may detect a magnitude value of about 50 dB. The audio captured by the pendant via the dipole microphone 228 in the orthogonal detection zone will detect a magnitude value that is less than both of the other microphones, for example, only of about 40 dB. Background noise may be present at a value of about 30 dB. The audio signals captured by microphone 222 may be timestamped and identified by certain magnitude values. The other microphones 226 and 228 may also perform magnitude identification and timestamping. The combination of detected audio values can be used to identify the DOA of the audio signals and determine that the person detected at that location is a particular person with a particular profile based on the processing of the audio data.

FIG. 2D illustrates an internal view of the top half of an exemplary microphone pendant configuration for capturing audio data to be encoded, processed and analyzed by one or more embodiments. The exemplary microphone pendant configuration may include various electronic components. Referring to FIG. 2D, the electronic components of the pendant are illustrated as one example configuration which may vary depending on the design considerations imposed as recognize by one skilled in the art. In this example configuration, the pendant 100 includes a microphone array 310 of microphones including a combination of omnidirectional and dipole microphones, a processor 312, a memory 314, an accelerometer 316 (e.g., six axis), a clock 318, a DSP 320, a battery 322, a switch 324 and a charging interface 326. Other components may also be included or removed from this configuration depending on the design considerations known to those skilled in the art.

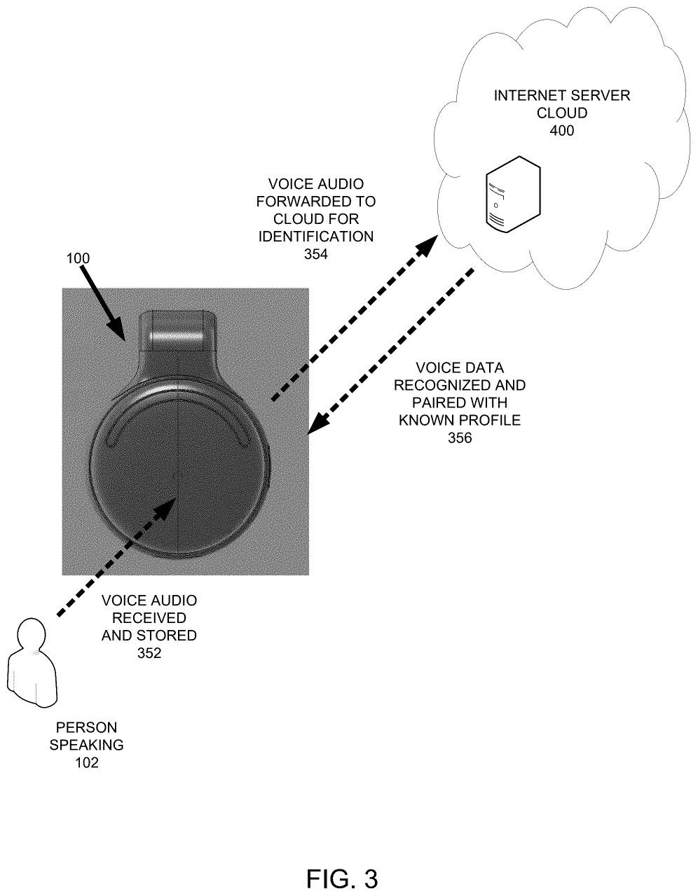

FIG. 3 illustrates a system diagram for transmitting the received audio data to a remote cloud server to perform audio data diarization processing according to example embodiments. Referring to FIG. 3, the system configuration illustrates the pendant device 100 receiving audio data 352 from a person 102 and forwarding the data 354 to a remote cloud server 400 for processing to determine the DOAs and to identify the person speaking for each audio segment identified. Such data 356 may be provided back to the pendant 100 which may update an application on mobile device or laptop computer to identify accurate pairings of persons with transcribed audio data.

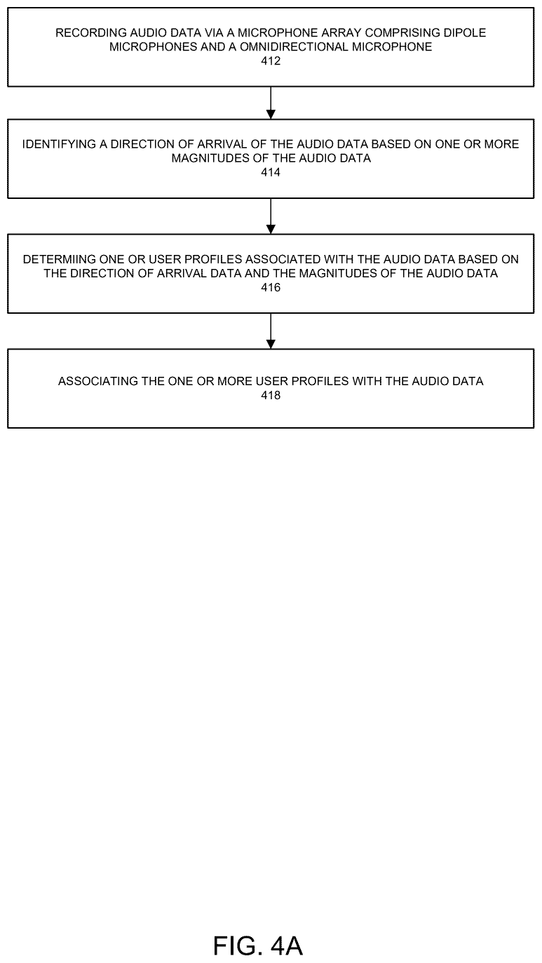

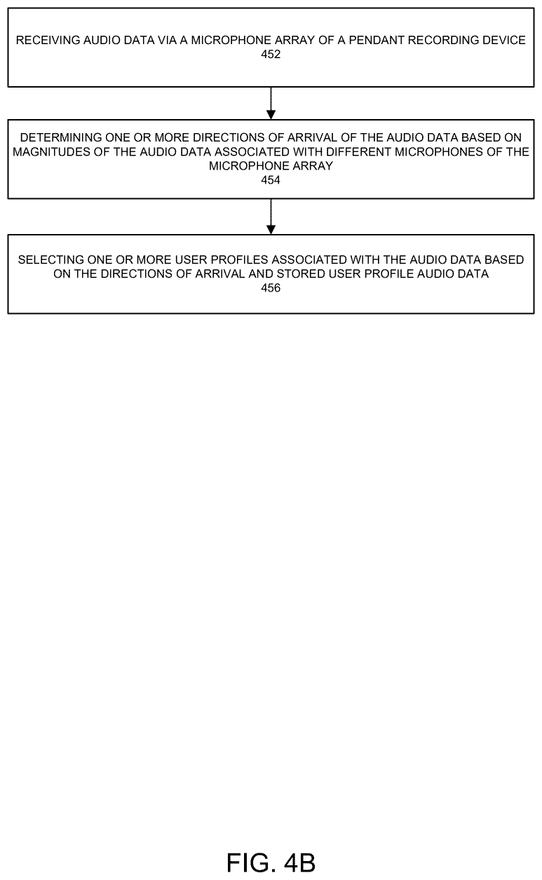

FIG. 4A illustrates an example process of performing audio data processing according to example embodiments. Referring to FIG. 4A, one example process may include recording audio data 412 via a microphone array that includes three microphones, such as a two dipole microphones arranged orthogonal to one another and an omnidirectional microphone arranged between the two dipole microphones. The process may also include identifying one or more directions of arrival 414 of the audio data based on magnitudes of the audio detected by one or more of the microphones. The process may also include determining one or more user profiles associated with the audio data based on the direction of arrival data and/or the magnitudes of the audio data 416. The process may also include associating the user profiles with the audio data 418 to pair users with spoken audio segments which are transcribed and presented to an application that identifies transcribed audio with user names.

FIG. 4B illustrates another example process of performing audio data processing according to example embodiments. Referring to FIG. 4B, the process may include receiving audio data via a microphone array of a pendant recording device 452. The process may also include determining one or more directions of arrival of the audio data based on the magnitudes of the audio data recorded 454 for each of the microphones of the microphone array. The process may further include selecting one or more user profiles associated with the audio data based on the direction of arrival data and the user profile audio data 456. According to one example, using the three microphones requires a time clock to timestamp all of the audio data received and recorded. One way to ensure accurate time information is to use a Nordic time chip.

As audio is detected, recorded and stored, the audio is detected by all active microphones of the pendant device at varying levels of magnitude (dB). The audio can then be used to identify a person's voice fingerprint stored in memory at the server and/or the device. In general, the device may isolate the background noise, and combine the audio from all active microphones into an audio stream and send the audio stream to a remote server for data processing. The device can connect via Wi-Fi to the remote server to forward the recorded audio data. The device may also use other wireless protocols, such as BLUETOOTH to transmit the audio data to other nearby devices, such as a smartphone, computer, etc.

As audio data is received during the course of a conversation of multiple speakers/persons, the audio data may be received and stored in segments between times when no one is speaking by removing portions of the audio which may include background noise and other audio that is below a certain magnitude threshold (i.e., 30, 40, ‘N’, dB). The relevant audio segments remaining may be grouped together. Each audio segment may be paired with a user profile of an identified speaker. Different speakers may be identified during an audio encoding process. Each audio segment may be timestamped and used to determine a DOA associated with that particular audio segment. Text transcriptions may be outputted for each audio segment along with speaker identifiers to enable pairing the speakers with the audio segments. In one audio session, such as a conference in a particular location, the audio identifiers and other embedded data may be stored and paired with future conversations to pair the known speakers from previous conferencing sessions with current and future conferencing sessions. New persons can be identified at any time during a conference and added to a user profile list of known persons. The audio data segments (chunks) may be received, processed and sliced into segments with active conversation data while other audio segments are removed. Certain text and speaker identifiers are returned to a user interface and/or memory location from the processed audio data. Each speaker may be assigned a speaker number and/or a name based on the pairing process. Multiple concurrent speakers can be identified based on recorded audio magnitude levels and calculated DOAs. The determined DOAs identified at different particular times can further ensure the likelihood of pairing a particular speaker with a particular audio segment. The resulting assignment of a speaker identifier to a particular audio segment based on audio fingerprints and calculated DOAs becomes increasingly accurate during the course of a multi-speaker in-person conference.

One example process may include receiving audio data comprising audio from one or more persons speaking and background noise and adding a timestamp to the audio data, determining a direction of arrival of the audio data based on detected magnitudes of the audio data and the timestamp, comparing the direction of arrival data to a plurality of audio data fingerprints associated with a plurality of profiles to identify a profile of an individual person that was speaking at a particular time, and assigning the identified profile to one or more portions of the audio data.

The audio data may include one set of audio data from a first audio channel and a second set of audio data from a second audio channel disposed orthogonal to the first audio channel. The direction of arrival data is used to determine separation between a first set of contiguous portions of an audio file representing a first voice of a first individual and a second set of contiguous portions of the audio file representing a second voice of a second individual.

Although an exemplary embodiment of at least one of a system, method, and non-transitory computer readable media has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, the capabilities of the system of the various figures can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way but is intended to provide one example of many embodiments. Indeed, methods, systems and apparatuses disclosed herein may be implemented in localized and distributed forms consistent with computing technology.

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

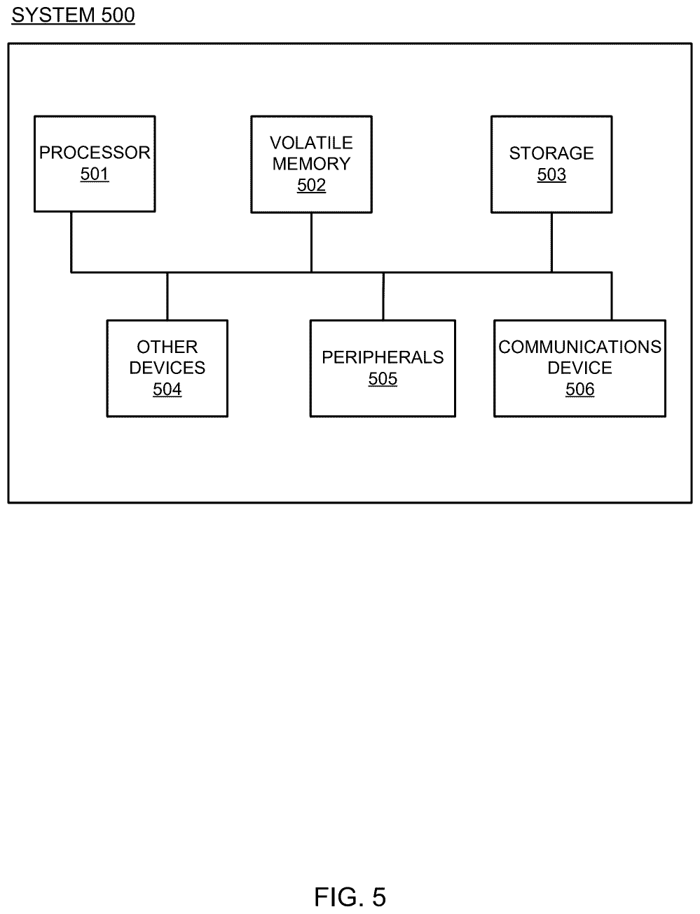

FIG. 5 is a diagram illustrating an exemplary computer that may perform processing in some embodiments. Exemplary computer 500 may perform operations consistent with some embodiments. The architecture of computer 500 is exemplary. Computers can be implemented in a variety of other ways. A wide variety of computers can be used in accordance with the embodiments herein.

Processor 501 may perform computing functions such as running computer programs. The volatile memory 502 may provide temporary storage of data for the processor 501. RAM is one kind of volatile memory. Volatile memory typically requires power to maintain its stored information. Storage 503 provides computer storage for data, instructions, and/or arbitrary information. Non-volatile memory, which can preserve data even when not powered and including disks and flash memory, is an example of storage. Storage 503 may be organized as a file system, database, or in other ways. Data, instructions, and information may be loaded from storage 503 into volatile memory 502 for processing by the processor 501.

The computer 500 may include peripherals 505. Peripherals 505 may include input peripherals such as a keyboard, mouse, trackball, video camera, microphone, and other input devices. Peripherals 505 may also include output devices such as a display. Peripherals 505 may include removable media devices such as CD-R and DVD-R recorders/players. Communications device 506 may connect the computer 100 to an external medium. For example, communications device 506 may take the form of a network adapter that provides communications to a network. A computer 500 may also include a variety of other devices 504. The various components of the computer 500 may be connected by a connection medium such as a bus, crossbar, or network.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

It should be noted that some of the system features described in this specification have been presented as modules to more particularly emphasize their implementation independence. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field-programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations that, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order and/or with hardware elements in configurations that are different from those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

1. A wearable device comprising:
a first housing comprising a plurality of electrical components comprising:
a plurality of microphones;
a memory; and
a processor;
a second housing comprising a battery;
a flexible neck portion connecting the first housing with the second housing;
a first magnet positioned in the first housing or the back side housing;
wherein the flexible neck portion comprises a conduit, wherein the conduit provides power to the plurality of electrical components via the battery.

2. The wearable device of claim 1, wherein the plurality of microphones receives audio signals from a grill or open portion disposed as an arced portion on the first housing.

3. The wearable device of claim 1, further comprising a second magnet or a ferrous material which hold together via a magnetic the first housing and the back side housing.

4. The wearable device of claim 1, wherein the first side comprises electronic components, and wherein the first housing comprises a power control button that allows power to the electronic components.

5. The wearable device of claim 1, wherein the first housing and the second housing each have a circularly shaped housing.

6. The wearable device of claim 1, further comprising a first channel component and a second channel component each having openings and hollow paths, wherein the plurality of microphones comprise a first dipole microphone and a second dipole microphones and an omnidirectional microphone, wherein the first dipole microphone is positioned next to an opening of the first channel component, and the second dipole microphone is positioned next to an opening of the second channel component.

7. The wearable device of claim 6, wherein ends of the first channel component and the second channel component are aligned with a respective underside of the first dipole microphones and the second dipole microphone to permit sound to travel along the hollow paths of the first and second channels

8. The wearable device of claim 6, wherein the first channel component and the second channel component are positioned orthogonal to one another that provide orthogonal audio capturing elements.

9. The wearable device of claim 6, wherein the first channel component and the second channel component are disposed under a grill such that sound can pass through the grill and into channel component and the second channel component.

10. The wearable device of claim 6, wherein the first channel component provides the first dipole microphone with a first set of listening zones, and the second channel component provides the second dipole microphone with a second set of listening zones.

11. The wearable device of claim 1, wherein the processor is configured to perform operations of:
receiving audio data from the plurality of microphones;
determining a direction of arrival of the audio data to the plurality of microphones; and
based on the determined direction of arrival, identifying that the received audio data is from a first individual and a second individual.

12. The wearable device of claim 6, wherein the processor is configured to perform operations of:
receiving audio data from the plurality of microphones; and
determining one or more user profiles associated with the audio data based on a direction of arrival and a magnitude of the audio data.

13. he wearable device of claim 1, wherein the flexible neck portion has a curved portion with a first longitudinal portion extending from a first side of the curved portion and a second longitudinal portion extending from a second side of the curved portion, wherein the first longitudinal portion connects to the first housing and the second longitudinal portion connects to the second housing.

14. The wearable device of claim 6, wherein an interior side of the first housing magnetically connects with an interior side of the second housing.

15. A wearable device comprising:
a first housing comprising a plurality of electrical components comprising:
a plurality of microphones, comprising a plurality of dipole microphones and a plurality of omnidirectional microphones;
a memory; and
a processor;
a second housing comprising a battery;
a flexible neck portion connecting the first housing with the second housing;
a first magnet positioned in the first housing or the back side housing; and
a second magnet or a ferrous material which holds together via a magnetic force the first housing and the back side housing;
wherein an interior side of the first housing magnetically connects with an interior side of the second housing; and
wherein the flexible neck portion comprises a conduit, wherein the conduit provides power to the plurality of electrical components via the battery, and wherein the flexible neck portion has a curved portion with a first longitudinal portion extending from a first side of the curved portion and a second longitudinal portion extending from a second side of the curved portion, wherein the first longitudinal portion connects to the first housing and the second longitudinal portion connects to the second housing.

16. The wearable device of claim 15, wherein the first side comprises electronic components, and wherein the first housing comprises a power control button that allows power to the electronic components.

17. The wearable device of claim 16, wherein the plurality of microphones receives audio signals from a grill or an open portion which is disposed on the first housing.

18. The wearable device of claim 15, further comprising a first channel component and a second channel component each having openings and hollow paths, wherein the plurality of microphones comprise a first dipole microphone and a second dipole microphones and an omnidirectional microphone, wherein the first dipole microphone is positioned next to an opening of the first channel component, and the second dipole microphone is positioned next to an opening of the second channel component.

19. The wearable device of claim 15, wherein ends of the first channel component and the second channel component are aligned with a respective underside of the first dipole microphones and the second dipole microphone to permit sound to travel along the hollow paths of the first and second channels

20. The wearable device of claim 15, wherein the first channel component and the second channel component are positioned orthogonal to one another that provide orthogonal audio capturing elements.
